(19) United States
(12) Patent Application Publication
(10) Pub. No.: US 2013/0145296 A1
(43) Pub. Date: Jun. 6, 2013

(54) DYNAMIC ICON ORDERING IN A USER INTERFACE

(71) Applicant: David M. Stecher, Durham, NC (US)

(72) Inventor: David M. Stecher, Durham, NC (US)

(73) Assignee: International Business Machines Corporation, Armonk, NY (US)

(21) Appl. No.: 13/309,128

(22) Filed: Dec. 1, 2011

(51) Int. Cl. G06F 3/048

(52) U.S. Cl. 715/765

(57) ABSTRACT

An icon ordering unit determines an icon order of a set of icons in a graphical user interface. The icon ordering unit identifies a set of icons from a plurality of icons that satisfy a filtering rule and further determines icon ordering parameters that satisfy a parameter icon ordering rule. The icon ordering unit determines a conversion value from a value of each of the icon ordering parameters according to a set of one or more conversion rules. The icon ordering unit normalizes each of the conversion values to generate normalized values of the icon ordering parameters. For each of the set of icons, the icon ordering unit aggregates the normalized values of the icon ordering parameters for the icon to generate an aggregate normalized value. The icon ordering unit determines an order for displaying the set of icons based, at least in part, on the aggregate normalized values.

### BACKGROUND

Embodiments of the inventive subject matter generally relate to the field of computer user interfaces, and, more particularly, to dynamically ordering icons in a user interface.

User interfaces have a limited space, which limits the number of icons that can be legibly displayed at a time. Icons are prioritized for display in an order of relevance for the user. Systems prioritize icons based on a number of times an icon was clicked in the past and on past use of the icons.

### SUMMARY

Embodiments of the inventive subject matter include a method to determine an icon order of a set of icons in a graphical user interface. The method identifies a set of icons from a plurality of icons that satisfy a filtering rule. The method determines icon ordering parameters that satisfy a parameter icon ordering rule. The parameter icon ordering rule specifies the icon ordering parameters that influence ordering of the set of icons. The method determines a conversion value from a value of each of the icon ordering parameters according to a set of one or more conversion rules for the icon ordering parameters. The method normalizes each of the conversion values to generate normalized values of the icon ordering parameters. Normalization is accomplished in accordance with normalization rules for the icon ordering parameters. For each of the set of icons, the method aggregates the normalized values of the icon ordering parameters for the icon to generate an aggregate normalized value. The method determines an order for displaying the set of icons based, at least in part, on the aggregate normalized values. The method generates program instructions to display the set of icons in accordance with the order.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of an icon ordering program determining an icon order on a Thursday morning.

FIG. 2 depicts an example conceptual diagram of an icon ordering program determining an icon order on a Saturday afternoon.

FIG. 3 illustrates a flow diagram of example operations to determine an icon order based, at least in part, on icon ordering rules.

FIG. 4 illustrates a flow diagram of example operations that continue from FIG. 3.

FIG. 5 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to an icon ordering program existing outside the operating system, the icon ordering program may be embedded into the operating system. In other instances, well-known instruction instances, protocols, structures and techniques have not been shown in detail in order not to obfuscate the description.

An icon ordering program interacts with an operating system in a computer to monitor user's interaction with the operating system. The term “program” is used herein to refer to either a set of computer program instructions or to an executing instance of the set of computer program instructions. The icon ordering program determines an icon order in a graphical user interface in accordance with user behavior. The icon ordering program uses parameters that correspond to user behavior (“icon ordering parameters”). Examples of icon ordering parameters include a number of clicks on a particular icon to run a program, duration of a program in the foreground, a number of clicks by the user in a program, a day of the week when a program was last run, a time of day when a program was last run, etc. Although examples refer to clicks on a mouse by a user, embodiments can be implemented with a touchscreen. The icon ordering program determines the icon ordering parameters by interacting with different components of the operating system (e.g. device drivers).

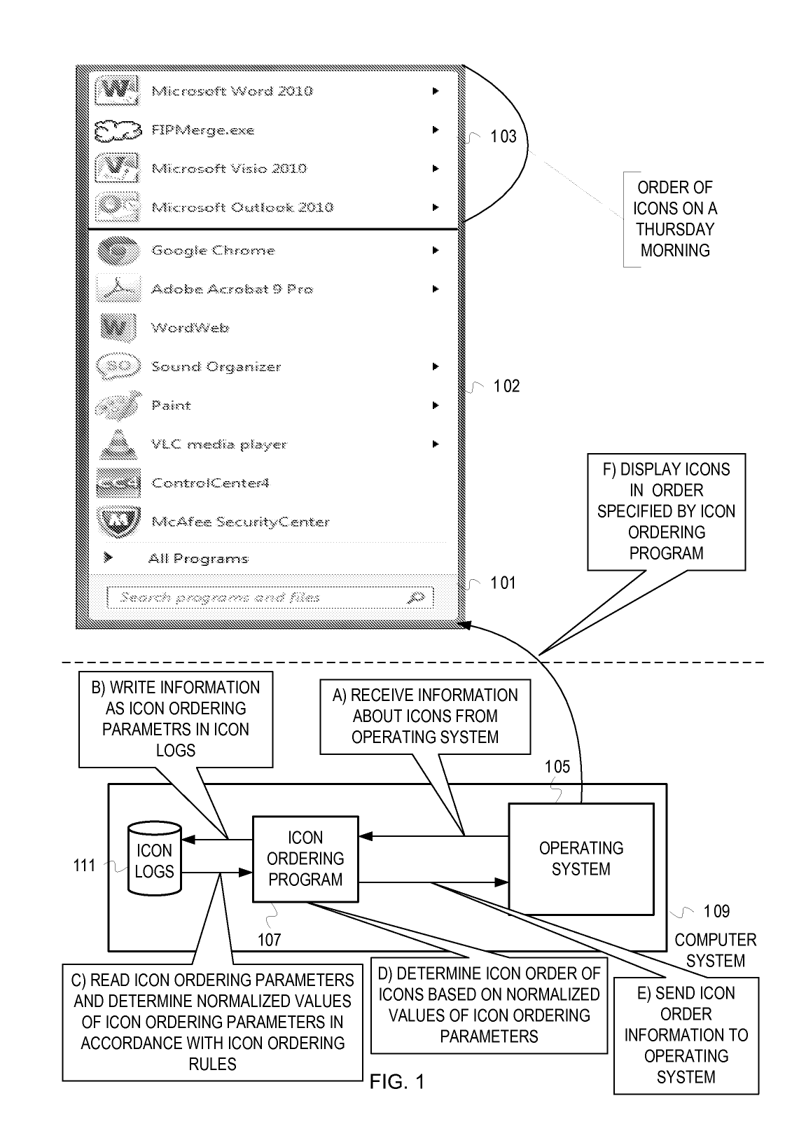

FIG. 1 depicts an example conceptual diagram of an icon ordering program determining an icon order on a Thursday morning. FIG. 1 comprises two parts: a screenshot 101 and a computer system 109. A dashed line separates the screenshot 101 and the computer system 109. The computer system 109 includes an operating system 105, an icon ordering program 107 and icon logs 111. The icon ordering program 107 includes program instructions to determine an icon order of icons in a user interface for the operating system 105. The icon logs 111 hold information about icons as icon ordering parameters for each icon including number of clicks on an icon to run a program, date of last run, time of last run, etc. The icon logs 111 are stored as data structures (e.g., tables, arrays, lists, etc.). The screenshot 101 depicts a start menu in a Microsoft Windows® 7 operating system. The screenshot 101 comprises two sections: a most frequently used list 102 and a pinned list 103 of the start menu. The most frequently used list 102 and the pinned list 103 are separated by a thick solid line. The icon ordering program 107 determines an order of icons in the pinned list 103. The screenshot 101 depicts order of icons in the pinned list 103 on a Thursday morning. The pinned list 103 depicts work-related programs relevant to a user on a weekday morning including Microsoft Office® programs. The icon ordering program 107 interacts with the operating system 105 and the icon logs 111 in a sequence of stages A through F.

At stage A, the icon ordering program 107 receives information about user activities from the operating system 105. The icon ordering program 107 may receive the information passively (e.g., the operating system 105 periodically sends the information), or actively (e.g., the icon ordering program 107 requests the information responsive to detecting an event or lapse of a time period). The information about user activities can include identifiers of programs run by the user, types of input/output devices used by the user, dates and times of executed programs, durations of programs in the foreground, etc. The icon ordering program 107 can receive the information from the operating system 105 by subscribing to a location where the operating system 105 service(s) publishes the information. In some embodiments, the icon ordering program 107 modifies the operating system program instructions to send information about user activities to the icon ordering program 107. In some embodiments, the icon ordering program 107 receives information by interacting directly with programs represented by the icons and with input/output device drivers. For example, an icon ordering program receives information about a time of day when the program was last run. The icon ordering program also receives information about the use of input/output devices at the time of day from the corresponding device drivers and correlates the information to determine icon ordering parameters. The operations of stage A continue through all the stages as the icon ordering program 107 continues to receive information about user activities from the operating system 105.

At stage B, the icon ordering program 107 writes the information received from the operating system 105 as icon ordering parameters for each icon in the icon logs 111. The icon ordering program 107 processes the information to identify relevant icon ordering parameters. The icon ordering parameters include number of clicks on an icon to run a program, duration of the program in the foreground (e.g., an active window on a user's screen), and a sum of the number of mouse clicks and keyboard entries (hereinafter, “program input entries”) by the user in the program. The icon ordering parameters also include days of the week when the program is run, and time(s) of day when the program is run. The icon ordering program 107 writes the entries for icon ordering parameters into the icon logs 111. The icon ordering program 107 deletes entries in the icon logs 111 preceding a certain time period. The icon ordering program 107 can also overwrite entries preceding a certain time period in the icon logs 111. The icon ordering program 107 can write the icon ordering parameters in different formats in accordance with the data structures (for example, table, arrays, lists, etc.) of the icon logs 111. The operations in stage B continue through all of the stages as the icon ordering program 107 continues to write into the icon logs 111.

At stage C, the icon ordering program 107 reads the icon ordering parameters for icons to be ordered and determines normalized values of the icon ordering parameters for the icons in accordance with icon ordering rules. The icon ordering rules are defined to establish a basis for ordering the icons. A system administrator can define a policy or configure program settings that define the icon ordering rules. A system administrator can define different sets of icon ordering rules based on different factors. Examples of the different factors may be user roles, type of machines, location of machine, temporal attributes, etc. A policy may include a first set of one or more icon ordering rules that operate to filter icons (“filtering icon ordering rules”), a second set of one or more icon ordering rules that specify which icon ordering parameters will influence ordering (“parameter icon ordering rules”), a third set of one or more icon ordering rules that specify the procedure of assigning a conversion value to an icon ordering parameter (“conversion rules”), a fourth set of one or more icon ordering rules that specify the procedure to normalize the conversion value assigned to an icon ordering parameter (“normalization rules”), and a fifth set of one or more icon ordering rules that specify the arrangement of icons in accordance with aggregate normalization values (“arrangement rules”). A filtering icon ordering rule(s) can limit icons to be ordered and displayed to icons that satisfy any one or more of a temporal condition (e.g., the program corresponding to the icon was run on the same day of the week as today), a property condition (e.g., the icon corresponds to a productivity type of program), etc. A parameter icon ordering rule specifies which icon ordering parameters will influence icon ordering, although a default could be that all parameters influence ordering. A conversion rule specifies the procedure to evaluate a numerical value for an icon ordering parameter. For example, a conversion rule specifies that a conversion value of 1 is assigned to the icon ordering parameter time of day, if a program was run within a range of 15 minutes of the current time. The range of 15 minutes of current time implies a period of 7.5 minutes before the current time and 7.5 minutes after the current time. Similarly, a conversion value of 0.75 is assigned if the program was run outside of the 15 minute window but within a range of 30 minutes of current time; a conversion value of 0.5 is assigned if the program was run within a range of 1 hour of the current time but outside of the 30 minute range; and a conversion value of 0.25 is assigned if the program was run within a range of 2 hours of the current time and outside of 1 hour. A conversion value of 0 is assigned to the time of day icon ordering parameter, if the program was run at any time outside a range of 2 hours of the current time. For the duration of program in foreground icon ordering parameter, a conversion rule specifies to assign a conversion value by multiplying the number of minutes with a coefficient (value=0.1). Time values for the duration of program in foreground are converted into minutes and rounded to next highest minute before being multiplied by the coefficient. For the program input entries icon ordering parameter, a conversion rule specifies to assign a conversion value by multiplying the number of program input entries with a coefficient (value=0.01). For the number of clicks on an icon to run a program icon ordering parameter, a conversion rule specifies to assign a conversion value by multiplying the numerical value of the number of clicks on an icon to run a program with a coefficient (value=0.5). A conversion rule also specifies to add conversion values of an icon ordering parameter when multiple entries for the icon ordering parameter of an icon are present in the icon logs 111. Multiple conversion rules for an icon ordering parameter may be programmed into the icon ordering program 107 to order icons in different user display menus. Coefficients mentioned in the example are only for the purpose of illustration. A normalization rule specifies the procedure to normalize the conversion value of an icon ordering parameter. For example, a normalization rule specifies to multiply the conversion value of the time of day icon ordering parameter with a coefficient (value=10). Similar normalization rules specify multiplication coefficients for conversion values of other icon ordering parameters. Normalization rules also specify an upper bound value and a lower bound value for the conversion value of an icon ordering parameter. When the conversion value obtained after multiplication with a coefficient specified by the normalization rule is less than the lower bound value, the normalization rule specifies the normalized value as the lower bound value. Similarly, when the conversion value obtained after multiplication with a coefficient specified by the normalization rules is greater than the upper bound value, the normalization rule specifies the normalized value as the upper bound value. Normalization rules allow the icon ordering program 107 to utilize all icon ordering parameters in an equal measure while determining the icon order of icons. Multiple normalization rules for an icon ordering parameter may be programmed into the icon ordering program 107 to order icons in different user display menus. An arrangement rule specifies the arrangement of icons in an icon order based on the aggregate normalized values of icons. For example, an arrangement rule specifies that the icon with highest aggregate normalized value is displayed at the top in the pinned list, followed by icons in decreasing order of their aggregate normalized values. An arrangement rule can also specify to hide an icon when the aggregate normalized value of the icon is less than a certain threshold of aggregate normalized value. In some embodiments, an arrangement rule specifies to highlight icons with aggregate normalized value greater than a certain value. The arrangement rule specifies display effects to highlight an icon, e.g., a higher display contrast for the icon as compared to other icons included in determining an icon order. The icon ordering program 107 writes the normalized values of icon ordering parameters for respective icons into a data structure in the memory.

At stage D, the icon ordering program 107 determines an icon order of icons based on normalized values of icon ordering parameters. The icon ordering program 107 determines an aggregate normalized value for each of the icons. The icon ordering program 107 determines the aggregate normalized value of an icon as a sum of normalized values of all icon ordering parameters of the icon. The icon ordering program 107 determines the icon order of icons based on aggregate normalized values of icons in accordance with arrangement rules.

At stage E, the icon ordering program 107 sends icon order information to the operating system 105. The icon ordering program 107 communicates the icon order information to a graphical user interface shell(s) (for example, Windows shell) in the operating system 105. In some embodiments, graphical user interface shells may not be a part of the operating system 105, and the icon ordering program 107 directly interacts with the graphical user interface shells. The icon ordering program 107 formulates program instructions for the graphical user shell(s) to display icons in a specified order. The icon ordering program 107 sends the program instructions to the graphical user shell(s). In some embodiments, the icon ordering program 107 only communicates a list of icon names, location details of icons, etc., in order of display to the graphical user shell(s). The icon ordering program 107 can also instruct the graphical user interface shell(s) to not display certain icons.

At stage F, the operating system 105 displays the icons in the order specified by the icon ordering program 107. A graphical user interface shell in the operating system 105 arranges the icons for display in the specified order.

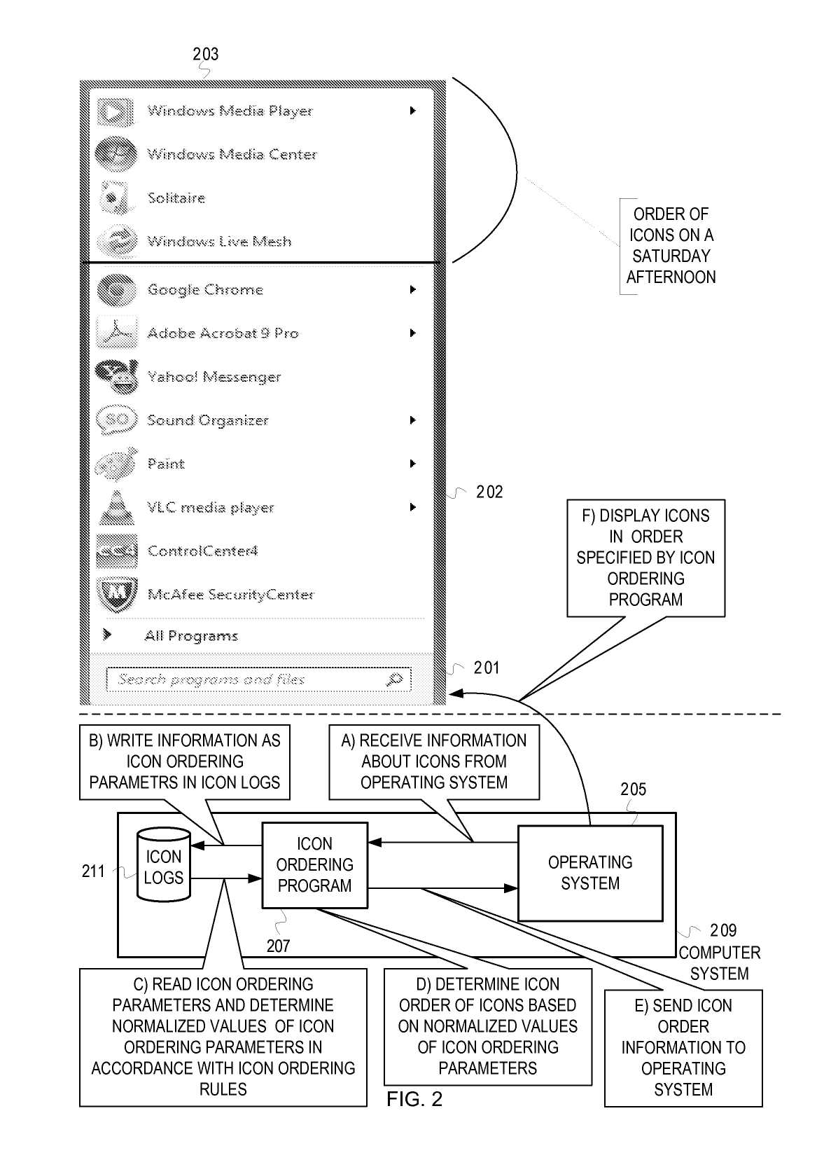

FIG. 2 depicts an example conceptual diagram of an icon ordering program determining an icon order on a Saturday afternoon. FIG. 2 comprises two parts, a screenshot 201 and a computer system 209. A dashed line separates the screenshot 201 and the computer system 209. The computer system 209 is similar to the computer system in FIG. 1. The entities in the computer system 209 include an operating system 205, an icon ordering program 207 and icon logs 211. The screenshot 201 includes a pinned list 203 and a most frequently used list 202. The pinned list 203 depicts an order of icons on a Saturday afternoon. The ordering of icons in the pinned list 203 can be observed in contrast with the ordering of icons in FIG. 1. The pinned list 203 depicts icons on a Saturday afternoon including icons for entertainment programs like Windows Media® Player, Windows Media Center, etc. The operations performed by the entities of the computer system 209 are similar to the operations described in FIG. 1.

At stage A, the icon ordering program 207 receives information about user activities from the operating system 205. The icon ordering program 207 may receive the information passively (e.g., the operating system 205 periodically sends the information), or actively (e.g., the icon ordering program 207 requests the information responsive to detecting an event or lapse of a time period). The information about user activities can include identifiers of programs run by the user, types of input/output devices used by the user, dates and times of executed programs, durations of programs in the foreground, etc. The icon ordering program 207 can receive the information from the operating system 205 by subscribing to a location where the operating system 205 service(s) publishes the information. In some embodiments, the icon ordering program 207 modifies the operating system program instructions to send information about user activities to the icon ordering program 207. In some embodiments, the icon ordering program 207 receives information by interacting directly with programs represented by the icons and with input/output device drivers. For example, an icon ordering program receives information about a time of day when the program was last run. The icon ordering program also receives information about the use of input/output devices at the time of day from the corresponding device drivers and correlates the information to determine icon ordering parameters. The operations of stage A continue through all the stages as the icon ordering program 207 continues to receive information about user activities from the operating system 205.

At stage B, the icon ordering program 207 writes the information received from the operating system 205 as icon ordering parameters for each icon in the icon logs 211. The icon ordering program 207 processes the information to identify relevant icon ordering parameters. The icon ordering parameters include number of clicks on an icon to run a program, duration of the program in the foreground (e.g., an active window on a user's screen), and a sum of the number of mouse clicks and keyboard entries (hereinafter, “program input entries”) by the user in the program. The icon ordering parameters also include days of the week when the program is run, and time(s) of day when the program is run. The icon ordering program 207 writes the icon ordering parameters into the icon logs 211. The icon ordering program 207 deletes entries in the icon logs 211 preceding a certain time period. The icon ordering program 207 can also overwrite entries preceding a certain time period in the icon logs 211. The icon ordering program 207 can write the icon ordering parameters in different formats in accordance with the data structures (for example, table, arrays, lists, etc.) of the icon logs 211. The operations in stage B continue through all of the stages as the icon ordering program 207 continues to write into the icon logs 211.

At stage C, the icon ordering program 207 reads the icon ordering parameters for icons to be ordered and determines normalized values of the icon ordering parameters for the icons in accordance with icon ordering rules. The icon ordering rules are defined to establish a basis for ordering the icons. A system administrator can define a policy or configure program settings that define the icon ordering rules. A system administrator can define different sets of icon ordering rules based on different factors. Examples of the different factors may be user roles, type of machines, location of machine, temporal attributes, etc. A policy may include a first set of one or more icon ordering rules that operate to filter icons (“filtering icon ordering rules”), a second set of one or more icon ordering rules that specify which icon ordering parameters will influence ordering (“parameter icon ordering rules”), a third set of one or more icon ordering rules that specify the procedure of assigning a conversion value to an icon ordering parameter (“conversion rules”), a fourth set of one or more icon ordering rules that specify the procedure to normalize the conversion value assigned to an icon ordering parameter (“normalization rules”), a fifth set of one or more icon ordering rules that specify the arrangement of icons in accordance with aggregate normalization values (“arrangement rules”). The icon ordering program 207 writes the normalized values of icon ordering parameters for respective icons into a data structure in the memory.

At stage D, the icon ordering program 207 determines an icon order of icons based on normalized values of icon ordering parameters. The icon ordering program 207 determines an aggregate normalized value for each of the icons. The icon ordering program 207 determines the aggregate normalized value of an icon as a sum of normalized values of all icon ordering parameters of the icon. The icon ordering program 207 determines the icon order of icons based on aggregate normalized values of icons in accordance with arrangement rules.

At stage E, the icon ordering program 207 sends icon order information to the operating system 205. The icon ordering program 207 communicates the icon order information to a graphical user interface shell(s) (for example, Windows shell) in the operating system 205. In some embodiments, graphical user interface shells may not be a part of the operating system 205, and the icon ordering program 207 directly interacts with the graphical user interface shells. The icon ordering program 207 formulates program instructions for the graphical user shell(s) to display icons in a specified order. The icon ordering program 207 sends the program instructions to the graphical user shell(s). In some embodiments, the icon ordering program 207 only communicates a list of icon names, location details of icons, etc., in order of display to the graphical user shell(s). The icon ordering program 207 can also instruct the graphical user interface shell(s) to not display certain icons.

At stage F, the operating system 205 displays the icons in the order specified by the icon ordering program 207. A graphical user interface shell in the operating system 205 arranges the icons in the specified order.

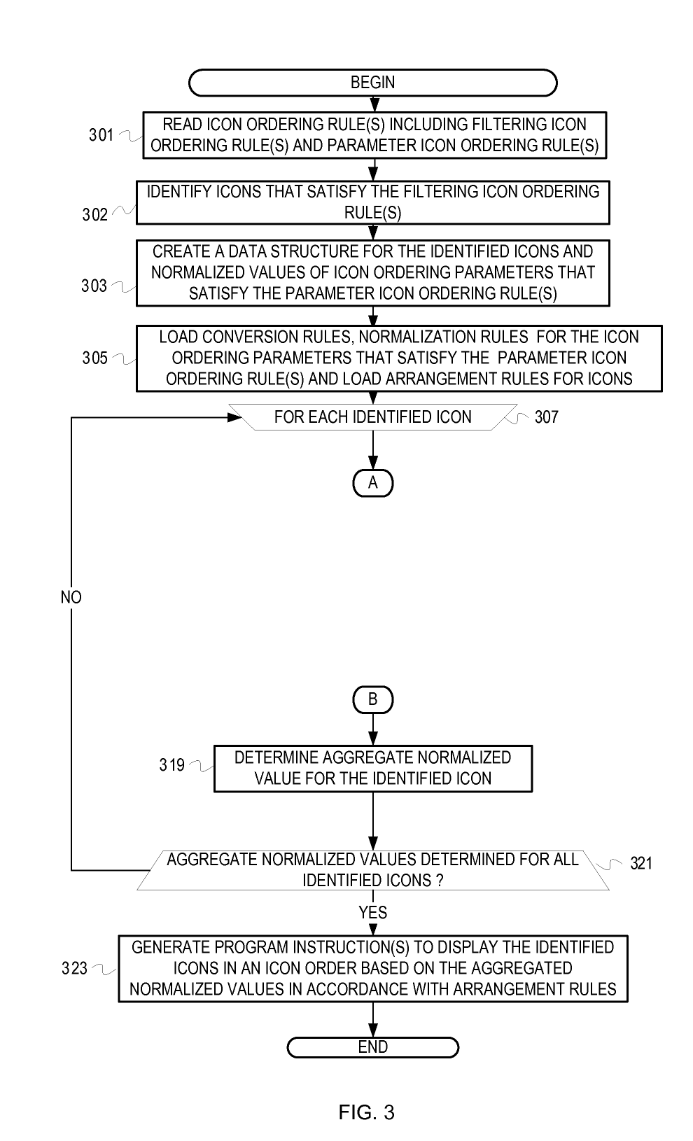

FIG. 3 illustrates a flow diagram of example operations to determine an icon order based, at least in part, on icon ordering rules.

At block 301, an icon ordering program reads an icon ordering rule(s) including filtering icon ordering rule(s) and parameter icon ordering rule(s). The icon ordering program reads program settings for a filtering icon ordering rule(s) and a parameter icon ordering rule(s).

At block 302, the icon ordering program identifies icons that satisfy the filtering icon ordering rule(s). The icon ordering program verifies properties of icons and information specified by the day of week icon ordering parameter, e.g., whether an icon is a part of a display menu, whether a program corresponding to an icon was run on the same day of week as today, etc. The icon ordering program only determines an icon order for the icons identified on the basis of the filtering icon ordering rule(s).

At block 303, the icon ordering program creates a data structure for the identified icons and normalized values of icon ordering parameters that satisfy the parameter icon ordering rule(s). The icon ordering program determines the icon ordering parameters that influence icon ordering on the basis of parameter icon ordering rule(s). The icon ordering program then creates a data structure in the memory to store normalized values of the icon ordering parameters. The icon ordering program initializes the entries in data structure with null values. For example, the icon ordering program creates a table in the memory. The rows in the table comprise icon identifiers (e.g., names of icons). The columns in the table comprise columns for the icon ordering parameters, and an aggregate normalized value column.

At block 305, the icon ordering program loads conversion rules and normalization rules for the icon ordering parameters that satisfy the parameter icon ordering rule(s). The icon ordering program also loads arrangement rules for icons. Conversion rules, normalization rules and arrangement rules are functions written into the icon ordering program. The icon ordering program loads the functions for conversion rules (“conversion rule functions”), normalization rules (“normalization rule functions”) and arrangement rules (“arrangement rule functions”) into the memory.

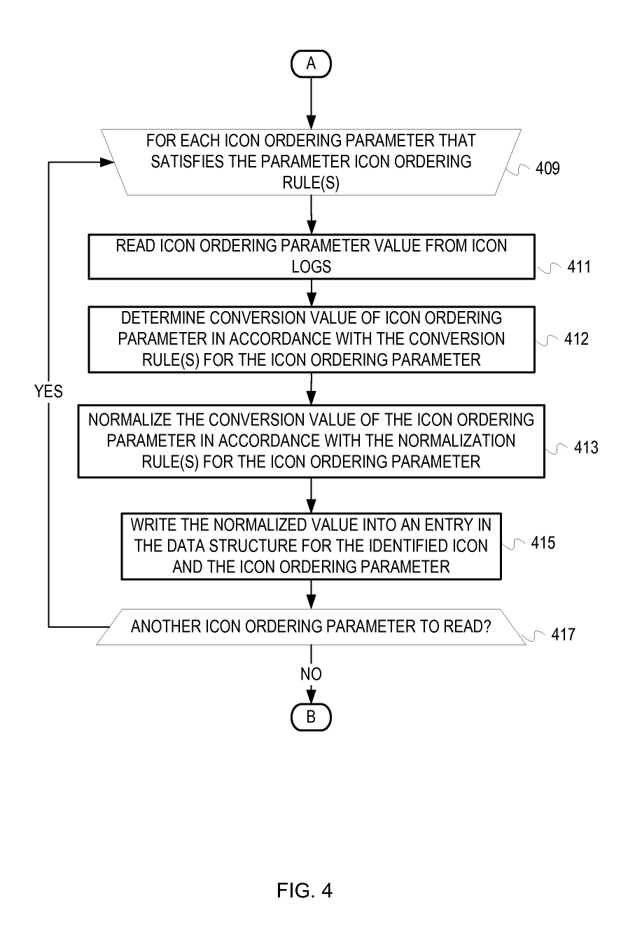

At block 307, the icon ordering program starts a loop for each of the icons identified at block 301. The loop includes operations at blocks 409, 411, 412, 413, 415 and 417 in FIG. 4. The loop also includes operations at blocks 319 and 321 in FIG. 3. From block 307, control flows to block 409 of FIG. 4.

FIG. 4 illustrates a flow diagram of example operations that continue from FIG. 3.

At block 409, the icon ordering program starts a loop for each of the icon ordering parameters that satisfy the parameter icon ordering rule(s). The loop includes operations at blocks 411, 412, 413, 415 and 417.

At block 411, the icon ordering program reads an icon ordering parameter value from icon logs. The icon ordering reads the data for the icon ordering parameter in the current iteration of the loop from the icon logs.

At block 412, the icon ordering program determines a conversion value for the icon ordering parameter in accordance with the conversion rule(s) for the icon ordering parameter. The icon ordering program passes the data for the icon ordering parameter into the conversion rule function(s). The conversion rule function(s) returns the conversion value of the icon ordering parameter. For example, the icon ordering program passes the time of day when the program was run to the conversion value function and the conversion value function returns a conversion value 1 when the time of day is within a range of 15 minutes of the current time.

At block 413, the icon ordering program normalizes the conversion value for the icon ordering parameter in accordance with the normalization rule(s) for the icon ordering parameter. The icon ordering program passes the conversion value for the icon ordering parameter into the normalization rule function(s). The normalization rule function(s) returns the normalized value of the icon ordering parameter. For example, the icon ordering program passes the conversion value (500) of duration of program in foreground. The normalization rule function multiplies the conversion value with a coefficient 0.5. The normalization rule function determines that the result of multiplication is greater than an upper bound value (100) and the normalization rule function returns the normalized value of duration of program as 100.

At block 415, the icon ordering program writes the normalized value of the icon ordering parameter for the identified icon into an entry in the data structure. For example, the icon ordering program writes the normalized value of the icon ordering parameter into a cell in the table. The cell in the table corresponds to the row for the identified icon and the column for the corresponding icon ordering parameter.

At block 417, the icon ordering program determines if there is another icon ordering parameter to be read for the identified icon in the current iteration of the loop. The icon ordering program verifies whether normalized values have been written for all the icon ordering parameters in the data structure. The absence of normalized values in the data structure for columns of the icon ordering parameters implies that another icon ordering parameter is to be read. If there is another icon ordering parameter to be read, control flows to block 409. If there is no other icon ordering parameter to be read, control flows to block 319 of FIG. 3.

At block 319, the icon ordering program determines an aggregate normalized value for the identified icon. The icon ordering program determines the aggregate normalized value for the identified icon as the sum of normalized values of icon ordering parameters for the icons. The icon ordering program writes the aggregate normalized value for the icon into an entry in the data structure. For example, the icon ordering program writes the aggregate normalized value for the icon into a cell in the table. The cell in the table corresponds to the row for the identified icon in the current iteration of the loop and the column for the aggregate normalized value.

At block 321, the icon ordering program determines whether aggregate normalized values have been determined for all the identified icons. The icon ordering program verifies that no null values for the aggregate normalized value column are present in the data structure. If aggregate normalized values have been determined for all the identified icons, control flows to block 323. If aggregate normalized values have not been determined for all the identified icons, control flows to block 307.

At block 323, the icon ordering program generates program instruction(s) to display the identified icons in an icon order based on the aggregate normalized values in accordance with arrangement rules. The icon ordering program passes the icon identifier and the normalized values of icons to the arrangement function. The arrangement function returns the icon order for the identified icons. In some embodiments, the arrangement function returns additional display effects for an icon (e.g., to highlight an icon). The icon ordering program formulates program instruction(s) to display the icons in accordance with the icon order and sends the program instruction(s) to a graphical user interface shell in the operating system.

Those of ordinary skill in the art should understand that the depicted flowcharts are examples to aid in understanding the inventive subject matter, and should not be used to limit the scope of the claims. Although the flow diagram illustrates ordering of icons in a single display menu. The icon ordering program can perform similar operations to order icons in multiple display menus at the same time. Embodiments can perform additional operations not depicted, fewer than the depicted operations, the operations in a different order, the operations in parallel, etc. The data structures used to assign normalized values to icon ordering parameters is not limited to a table. Any two dimensional data structures can be used to assign normalized values and compute aggregate normalized values. For example, the icon ordering program can utilize a two-dimensional array to assign normalized values to icon ordering parameters for icons. Although not illustrated in the flow diagrams, the icon ordering program can include the icons not identified by filtering icon ordering rule(s) to determine the icon order of icons. In some embodiments, the icon ordering program includes the icons not identified by filtering icon ordering rules to determine the icon order when the number of identified icons is less than the number of icons that can be displayed in the user interface.

The icon ordering program can also use only some of the icon ordering parameters to determine the aggregate normalized value for an icon. The icon ordering program can use a single icon ordering parameter, or different combinations of icon ordering parameters to determine the aggregate normalized value for an icon. The icon ordering program can also use a weighted sum of normalized values of icon ordering parameters to determine the aggregate normalized value for an icon. The icon ordering program can use feedback information from the operating system services to improve computation of the normalized values for the icon ordering parameters. For example, the feedback information from operating system services indicates the programs actually used by the user at a certain time. The icon ordering program is not limited to ordering icons for a single user interface at a time and can interact with multiple user interfaces to order icons, at the same time.

The icon ordering program is not limited to computers, and can be implemented over a wide range of devices including smartphones, tablets, personal digital assistant, etc. The icon ordering program can also be implemented over a wide range of operating systems including Mac OS X®, Android®, etc. Ordering of icons in the start menu is only for the purpose of illustration. The use of icon ordering program is not limited to operating system programs. The icon ordering program can be used to order icons in a web browser (e.g. Firefox®, Safari®, etc.) and custom application programs. The icon ordering program is not limited to assigning an order of display for icons, but also modifying the layout of a user interface in accordance with user behavior.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

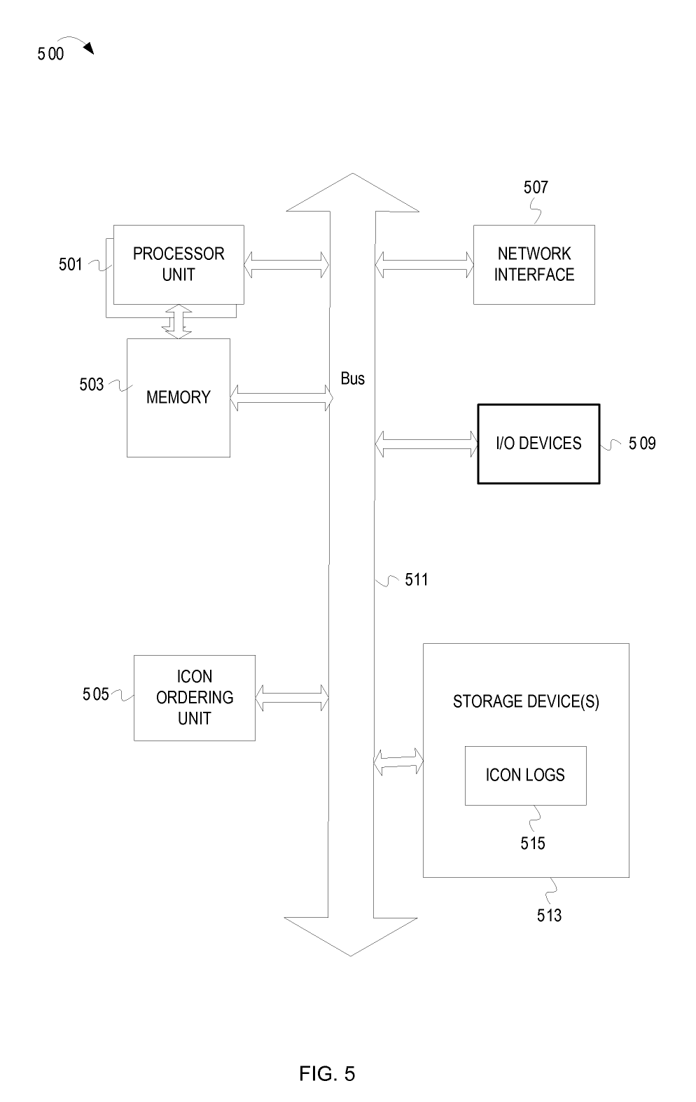

FIG. 5 depicts an example computer system 500. The computer system 500 includes a processor unit 501 (possibly including multiple processors, multiple cores, multiple nodes, and/or implementing multi-threading, etc.). The computer system includes a memory 503. The memory 503 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 511 (e.g., PCI, ISA, PCI-Express, HyperTransport®, InfiniBand®, NuBus, etc.), a network interface 507 (e.g., an ATM interface, an Ethernet interface, a Frame Relay interface, SONET interface, wireless interface, etc.), I/O devices 509 (e.g. keyboard, mouse, monitor, microphone, speaker, etc.), an icon ordering unit 505, a storage device(s) 513 (e.g., optical storage, magnetic storage, etc.) and icon logs 515. The icon logs 515 are embodied in the storage device(s) 513. The icon logs 515 may be embodied in the memory 503. The icon logs 515 are stored as data structures (e.g., table, list, array, etc.). The icon ordering unit 505 receives information about user behavior from an operating system and writes the information as icon ordering parameters for icons into the icon logs 515. The icon ordering unit 505 reads icon ordering parameters from the icon logs 515 and determines an icon order of icons. The icon ordering unit 505 sends information about the icon order to the operating system. The icon ordering unit 505 may be a hardware chip (e.g., PLA, PAL, FPGA, etc.) programmed with program instructions to perform the functionality as described above. The icon ordering unit 505 may be implemented with an application specific integrated circuit, in logic implemented in the processor unit 501, in a co-processor on a peripheral device or card, etc. In addition, at least some of the functionality of the icon ordering unit 505 may be embodied as program instructions in the memory 503 or the storage device(s) 513. Further, realizations may include fewer or additional components not illustrated in FIG. 5 (e.g., video cards, audio cards, additional network interfaces, peripheral devices, etc.). The processor unit 501, the storage device(s) 513, and the network interface 507 are coupled to the bus 511. Although illustrated as being coupled to the bus 511, the memory 503 may be coupled to the processor unit 501.

While the embodiments are described with reference to various implementations and exploitations, it will be understood that these embodiments are illustrative and that the scope of the inventive subject matter is not limited to them. In general, techniques for icon ordering in a user interface as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
identifying from a plurality of icons a set of icons that satisfy a filtering rule;
determining icon ordering parameters that satisfy a parameter icon ordering rule, wherein the parameter icon ordering rule specifies the icon ordering parameters that influence ordering of the set of icons;
determining a conversion value from a value of each of the icon ordering parameters according to a set of one or more conversion rules for the icon ordering parameters;
normalizing each of the conversion values to generate normalized values of the icon ordering parameters, wherein said normalizing is in accordance with normalization rules for the icon ordering parameters;
for each of the set of icons, aggregating the normalized values of the icon ordering parameters for the icon to generate an aggregate normalized value;
determining an order for displaying the set of icons based, at least in part, on the aggregate normalized values;
generating program instructions to display the set of icons in accordance with the order.

2. The method of claim 1, wherein said identifying the set of icons that satisfy the filtering rule comprises identifying those of the plurality of icons corresponding to programs run on a same day of week as today as indicated by current system time.

3. The method of claim 1, wherein said determining the conversion value from the value of each of the icon ordering parameters comprises determining, for each of the icon ordering parameters, a numerical value from the value of the icon ordering parameter as specified by the conversion rules for the icon ordering parameter.

4. The method of claim 1, wherein said normalizing each of the conversion values to generate normalized values of the icon ordering parameters comprises, for each of the conversion values:
multiplying the conversion value by a coefficient as specified in the normalization rules; and
normalizing the conversion value by an upper bound value and a lower bound value specified by the normalization rules for a result of the multiplication.

5. The method of claim 1 further comprising:
generating second program instructions for displaying the set of icons in accordance with a set of arrangement rules for the set of icons, wherein the set of arrangement rules specify at least one of a threshold aggregate normalized value for limiting display of icons and display effects based on the aggregate icon ordering values.

6. The method of claim 1 further comprising loading a set of icon ordering rules based on a user role associated with a machine that hosts the icons, wherein the set of icon ordering rules comprise the filtering rule, the conversion rules, and the normalization rules.

7. A computer program product for determining an icon order in a graphical user interface, the computer program product comprising:
a computer readable storage medium having computer usable program code embodied therewith, the computer usable program code comprising a computer usable program code configured to:
identify from a plurality of icons a set of icons that satisfy a filtering rule;
determine icon ordering parameters that satisfy a parameter icon ordering rule, wherein the parameter icon ordering rule specifies the icon ordering parameters that influence ordering of the set of icons;
determine a conversion value from a value of each of the icon ordering parameters according to a set of one or more conversion rules for the icon ordering parameters;
normalize each of the conversion values to generate normalized values of the icon ordering parameters, wherein said normalization is in accordance with normalization rules for the icon ordering parameters;
for each of the set of icons, aggregate the normalized values of the icon ordering parameters for the icon to generate an aggregate normalized value;
determine an order for displaying the set of icons based, at least in part, on the aggregate normalized values;
generate program instructions to display the set of icons in accordance with the order.

8. The computer readable storage medium of claim 7, wherein the computer usable program code configured to identify the set of icons that satisfy the filtering rule comprises the computer usable program code configured to identify those of the plurality of icons corresponding to programs run on a same day of week as today as indicated by current system time.

9. The computer readable storage medium of claim 7, wherein the computer usable program code configured to determine the conversion value from the value of each of the icon ordering parameters comprises the computer usable program code configured to determine, for each of the icon ordering parameters, a numerical value from the value of the icon ordering parameter as specified by the conversion rules for the icon ordering parameter.

10. The computer readable storage medium of claim 7, wherein the computer usable program code configured to normalize each of the conversion values to generate normalized values of the icon ordering parameters comprises the computer usable program code configured to, for each of the conversion values:
multiply the conversion value by a coefficient as specified in the normalization rules; and
normalize the conversion value by an upper bound value and a lower bound value specified by the normalization rules for a result of the multiplication.

11. The computer readable storage medium of claim 7, wherein the computer usable program code is further configured to generate second program instructions for displaying the set of icons in accordance with a set of arrangement rules for the set of icons, wherein the set of arrangement rules specify at least one of a threshold aggregate normalized value for limiting display of icons and display effects based on the aggregate icon ordering values.

12. The computer readable storage medium of claim 7, wherein the computer usable program code is further configured to load a set of icon ordering rules based on a user role associated with a machine that hosts the icons, wherein the set of icon ordering rules comprise the filtering rule, the conversion rules, and the normalization rules.

13. An apparatus comprising:
a processor;
a network interface coupled with the processor; and
an icon ordering unit configured to:
identify from a plurality of icons a set of icons that satisfy a filtering rule;
determine icon ordering parameters that satisfy a parameter icon ordering rule, wherein the parameter icon ordering rule specifies the icon ordering parameters that influence ordering of the set of icons;
determine a conversion value from a value of each of the icon ordering parameters according to a set of one or more conversion rules for the icon ordering parameters;
normalize each of the conversion values to generate normalized values of the icon ordering parameters, wherein said normalization is in accordance with normalization rules for the icon ordering parameters;
for each of the set of icons, aggregate the normalized values of the icon ordering parameters for the icon to generate an aggregate normalized value;
determine an order for displaying the set of icons based, at least in part, on the aggregate normalized values;
generate program instructions to display the set of icons in accordance with the order.

14. The apparatus of claim 13, wherein the icon ordering unit configured to identify the set of icons that satisfy the filtering rule comprises the icon ordering unit configured to identify those of the plurality of icons corresponding to programs run on a same day of week as today as indicated by current system time.

15. The apparatus of claim 13, wherein the icon ordering unit configured to determine the conversion value from the value of each of the icon ordering parameters comprises the icon ordering unit configured to determine, for each of the icon ordering parameters, a numerical value from the value of the icon ordering parameter as specified by the conversion rules for the icon ordering parameter.

16. The apparatus of claim 13, wherein the icon ordering unit configured to normalize each of the conversion values to generate normalized values for each of the icon ordering parameters comprises the icon ordering unit configured to, for each of the conversion values:
multiply the conversion value by a coefficient as specified in the normalization rules; and
normalize the conversion value by an upper bound value and a lower bound value specified by the normalization rules for a result of the multiplication.

17. The apparatus of claim 13, wherein the icon ordering unit is further configured to generate second program instructions for displaying the set of icons in accordance with a set of arrangement rules for the set of icons, wherein the set of arrangement rules specify at least one of a threshold aggregate normalized value for limiting display of icons and display effects based on the aggregate icon ordering values.

18. The apparatus of claim 13, wherein the icon ordering unit is further configured to load a set of icon ordering rules based on a user role associated with a machine that hosts the icons, wherein the set of icon ordering rules comprise the filtering rule, the conversion rules, and the normalization rules.

19. The apparatus of claim 13 further comprising a machine-readable storage medium encoded with icon logs, wherein the icon ordering unit is further configured to read the value of each of the icon ordering parameters from the icon logs.

20. The apparatus of claim 13 further comprising a machine-readable storage medium that embodies the icon ordering unit as computer usable program code.
